(19) United States
(12) Patent Application Publication
(10) Pub. No.: US 2010/0207870 A1
(43) Pub. Date: Aug. 19, 2010

(54) DEVICE AND METHOD FOR INPUTTING SPECIAL SYMBOL IN APPARATUS HAVING TOUCH SCREEN

(75) Inventor: Moon-ok CHO, Seoul (KR)

Correspondence Address: H.C. PARK & ASSOCIATES, PLC, 8500 LEESBURG PIKE, SUITE 7500, VIENNA, VA, 22182, US

(73) Assignee: PANTECH&CURITEL COMMUNICATIONS, INC., Seoul (KR)

(21) Appl. No.: 12/546,422

(22) Filed: Aug. 24, 2009

(30) Foreign Application Priority Data
Feb. 19, 2009 (KR) 10-2009-0013925

(51) Int. Cl. G06F 3/041

(52) U.S. Cl. 345/156

(57) ABSTRACT

A device to input a special symbol in an apparatus having a touch screen includes a touch sensor to detect a user touch at a first position, a text input controller to switch from a general character input mode to a special symbol input mode if the user touch is maintained for at least a predetermined time, and a special symbol display unit to display a special symbol at the first position. A method for inputting a special symbol includes a touch detecting step of detecting the user touch at the first position, switching to the special symbol input mode if the user touch is maintained for at least a predetermined time, and displaying a special symbol at the first position in the special symbol input mode.

### CROSS-REFERENCE TO RELATED APPLICATION

This application claims priority from and the benefit of Korean Patent Application No. 10-2009-13925, filed on Feb. 19, 2009, which is hereby incorporated by reference for all purposes as if fully set forth herein.

### BACKGROUND OF THE INVENTION

1. Field of the Invention

The following description relates to character input technology, and more particularly, to a device and method for inputting a special symbol in an apparatus having a touch screen.

2. Discussion of the Background

Lately, apparatuses having touch screens have been attracting consumer attention. Generally, the touch screen is implemented as a replacement for a physical key pad or QWERTY keyboard. When a user wishes to type out Korean letters, capital Latin letters, lowercase Latin letters, numerals, etc. (collectively referred to as “characters”), the characters can be input by touching the touch screen. However, conventional special symbol input methods are inconvenient because they require switching from a general character input screen to a special symbol input screen to input a special symbol (including without limitation symbols such as ˜, !, @, $, %, ̂, &, *, (,), and punctuation marks), and then switching back from the special symbol input screen to the general character input screen to continue inputting characters. A new special symbol input method to be used with a touch screen is therefore needed.

### SUMMARY OF THE INVENTION

Exemplary embodiments of the present invention provide a special symbol input device and method in an apparatus having a touch screen that permits a user to input a special symbol while in a general character input screen without switching to a special symbol input screen.

Additional aspects of the invention will be set forth in the description which follows, and in part will be apparent from the description, or may be learned by practice of the invention.

An exemplary embodiment of the present invention discloses a device to input a special symbol in an apparatus having a touch screen, including a touch sensor to detect a user touch at a first position, a text input controller to switch from a general character input mode to a special symbol input mode if the user touch is maintained for at least a predetermined time, and a special symbol display unit to display a special symbol at the first position if the text input controller is switched to the special symbol input mode.

An exemplary embodiment of the present invention discloses a method for inputting a special symbol in an apparatus having a touch screen, including a touch detecting step of detecting a user touch at a first position, a special symbol input switching step of switching from a general character input mode to a special symbol input mode if the user touch is maintained for at least a predetermined time, and a special symbol display step of displaying a special symbol at the first position in the special symbol input mode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of a device for inputting a special symbol in an apparatus having a touch screen according to an exemplary embodiment of the present invention.

FIG. 2 is an example of an index table in which characters and special symbols are mapped to each other.

FIG. 3 illustrates an example of a user interface for mapping between specific characters and special symbols.

FIG. 4 is a flowchart illustrating a method for inputting a special symbol in an apparatus having a touch screen according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. Like reference numerals in the drawings denote like elements.

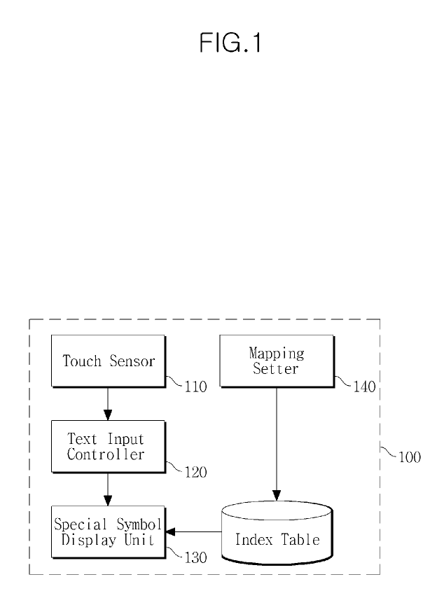

FIG. 1 is a block diagram of a device 100 for inputting a special symbol in an apparatus having a touch screen according to an exemplary embodiment of the present invention. As shown in the drawing, the device 100 includes a touch sensor 110, a text input controller 120, and a special symbol display unit 130.

The touch sensor 110 detects a user touch at a specific position while the apparatus is in a general character input mode. The apparatus may be in the general character input mode when a user of an apparatus having a touch screen such as a cellular phone wants to input a text to, for example, type a short message.

In the general character input mode, the user inputs general characters by touching, clicking or dragging general character input keys displayed on the touch screen.

If the user wants to input a special symbol while inputting general characters in the general character input mode, the user may long-click a position at which a special symbol is to be inputted. If the user wants to move a cursor while inputting general characters in the general character input mode, the user may short-click a position to which the cursor is to be moved.

Here, a long click refers to a case in which the touch screen is pressed and held for at least a predetermined time, and a short click corresponds to a case in which the touch screen is pressed and held for less than the predetermined time. Although not limited as such, the predetermined time may be long enough so that a user can make a short click conveniently, but not so long that the user must wait excessively for the long click to be recognized.

The touch sensor 110 also detects whether a user touch is maintained for at least the predetermined time, or for less than the predetermined time.

If the user touch detected by the touch sensor 110 is maintained for at least the predetermined time and is characterized as a long click, the text input controller 120 switches from the general character input mode to the special symbol input mode. If the user touch detected by the touch sensor 110 is maintained for less than the predetermined time and is characterized as a short click, the text input controller 120 moves the cursor to the position corresponding to the user touch.

If the text input controller 120 switches to the special symbol input mode from the general character input mode, the special symbol display unit 130 displays a special symbol at the long click touch position detected by the touch sensor 110. Exemplary embodiments of displaying a special symbol will be described in more detail below.

If the touch sensor 110 in the special symbol input mode then detects a touch at another position other than the long click touch position, the special symbol display unit 130 finishes inputting the special symbol. In other words, if a touch position is changed from the first position to a second position while a special symbol is displayed, the special symbol display unit 130 inputs the special symbol at the first position, moves the cursor to the second position, and switches back to the general character input mode.

In summary, the device 100 for inputting a special symbol in an apparatus having a touch screen detects a user touch at a specific position while in the general character input mode, and if the detected user touch is maintained for at least a predetermined time and is a long click, the device 100 switches to the special symbol input mode and displays a special symbol at the detected touch position. Therefore, it is possible to input a special symbol in a general character input screen of the apparatus having a touch screen without switching to a special symbol input screen, and user convenience may be improved.

According to an exemplary embodiment, the special symbol display unit 130 may sequentially display a series of special symbols if the user touch is maintained while in the special symbol input mode.

More specifically, the special symbol display unit 130 may sequentially display a series of special symbols while in the special symbol input mode. As the user continuously maintains a touch at the position at which a special symbol is displayed, the special symbol display unit 130 sequentially displays the series of special symbols, one at a time. The speed at which the special symbol display unit 130 sequentially displays the series of special symbols may be the same as or different than the predetermined time described above. When the desired special symbol among the series of special symbols is displayed, the desired special symbol can be input by touching another position.

According to an exemplary embodiment, the apparatus having a touch screen may display multiple special symbols in the special symbol input mode in the special symbol display operation (S130). The special symbols may be displayed, and the user may select one of the displayed special symbols to be inputted by touching the desired special symbol. The apparatus may then return to the general character input mode after the desired special symbol is inputted.

According to an exemplary embodiment, the special symbol display unit 130 may display a special symbol mapped to a character at a touch position detected by the touch sensor 110. Here, the character and the special symbol may be mapped to each other on a one-to-one basis or a one-to-many basis.

More specifically, special symbols and specific characters may be mapped to each other on a one-to-one basis or a one-to-many basis, a special symbol mapped to a character at a touch position is displayed, and then the desired special symbol can be inputted by touching another position.

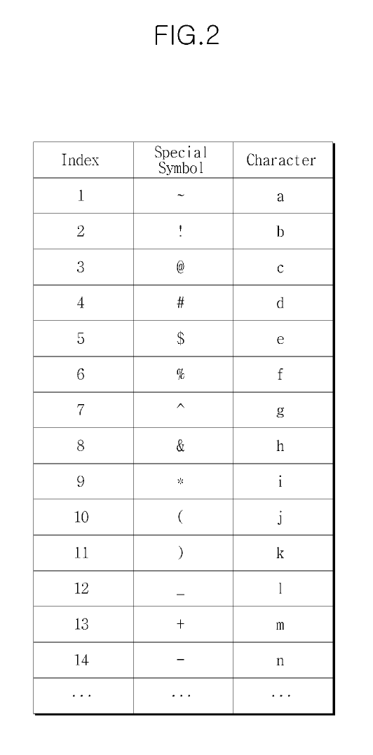

FIG. 2 is an example of an index table in which characters and special symbols are mapped to each other. From the top, special symbols “˜”, “!”, and “@” are mapped to “a”, “b”, and “c”, respectively, on a one-to-one basis.

According to an exemplary embodiment, the device 100 to input a special symbol in an apparatus having a touch screen may further include a mapping setter 140. The mapping setter 140 maps special symbols to specific characters.

More specifically, the mapping setter 140 sets one-to-one or one-to-many mapping between specific characters and special symbols. For example, a user interface inputting a specific character and a special symbol mapped to the specific character is provided by the mapping setter 140, and specific characters and special symbols are mapped to each other on a one-to-one basis or a one-to-many basis by the mapping setter 140.

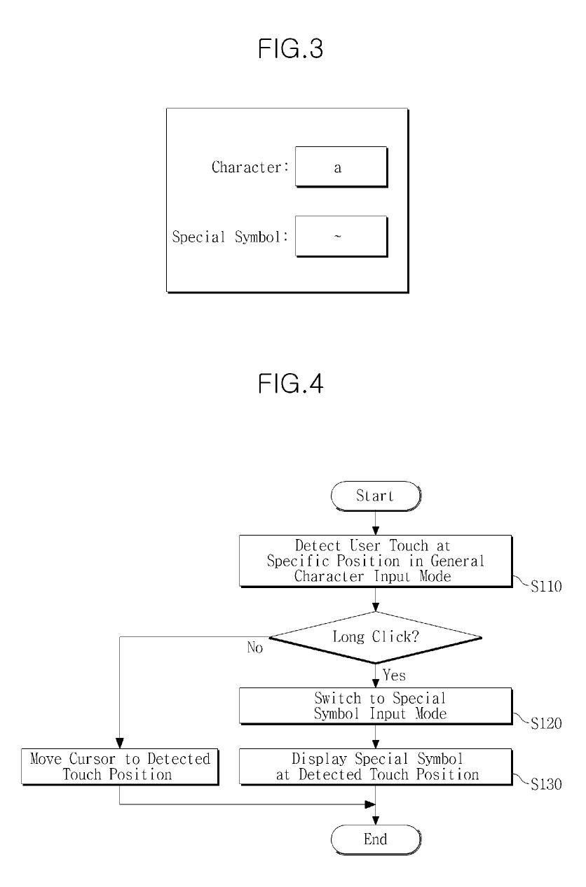

FIG. 3 illustrates an example of a user interface for mapping between specific characters and special symbols. As shown, a specific character “a” is mapped to a special symbol “˜”.

FIG. 4 is a flowchart illustrating a method for inputting a special symbol in an apparatus having a touch screen according to an exemplary embodiment. A special symbol input operation of the above-described device for inputting a special symbol in an apparatus having a touch screen according to an exemplary embodiment of the present invention will now be described with reference to FIG. 4.

The apparatus may be in the general character input mode when a user of an apparatus having a touch screen such as a cellular phone wants to input a text to, for example, type a short message.

Then, in a touch detecting operation (S110), the apparatus having a touch screen and in the general character input mode detects a user touch at a specific position.

If the user touch detected in the touch detecting operation (S110) is maintained for at least a predetermined time and is characterized as a long click, the apparatus having a touch screen switches to the special symbol input mode in a special symbol input switching operation (S120).

On the other hand, if the user touch detected in the touch detecting operation (S110) is maintained for less than the predetermined time and is characterized as a short click, the apparatus having a touch screen moves a cursor to a detected touch position.

If the apparatus switches to the special symbol input mode in the special symbol input switching operation (S120), the apparatus having a touch screen displays a special symbol at the touch position detected in the touch detecting operation (S110) in a special symbol display operation (S130).

In this way, an apparatus having a touch screen detects a user touch at a specific position in the general character input mode, and if the detected user touch is maintained for at least a predetermined time, the apparatus switches to the special symbol input mode and displays a special symbol at the detected touch position.

Meanwhile, according to an exemplary embodiment, the apparatus having a touch screen may sequentially display a series of special symbols in the special symbol input mode in the special symbol display operation (S130). The series of special symbols may be sequentially displayed, one at a time, if the user continuously maintains the touch at the touch location in the special symbol input mode.

More specifically, the apparatus having a touch screen sequentially displays a series of special symbols while in the special symbol input mode. Thus, as the user continuously maintains a touch at the position at which a special symbol is displayed, the series of special symbols is sequentially displayed. When the desired special symbol is displayed, it can be inputted by touching another position other than the touch position.

According to an exemplary embodiment, the apparatus having a touch screen may display multiple special symbols in the special symbol input mode in the special symbol display operation (S130). The special symbols may be displayed, and the user may select one of the displayed special symbols to be inputted by touching the desired special symbol. The apparatus may then return to the general character input mode after the desired special symbol is inputted.

Meanwhile, according to an exemplary embodiment, the apparatus having a touch screen may display a special symbol mapped to a character at the touch position detected in the touch detecting operation (S110) in the special symbol display operation (S130). Here, the character and the special symbol may be mapped to each other on a one-to-one basis or a one-to-many basis.

More specifically, the apparatus having a touch screen maps special symbols to specific characters on a one-to-one basis or a one-to-many basis, displays a special symbol mapped to a character at a touch position, and inputs the desired special symbol when another position, other than the touch position, is touched.

As apparent from the above description, the exemplary embodiments detect a user touch at a specific position while in a general character input mode, and if the detected user touch is maintained for at least a predetermined time, switch to a special symbol input mode and display a special symbol at the detected touch position. Therefore, it is possible to input a special symbol in a general character input screen of an apparatus having a touch screen without switching to a special symbol input screen, and user convenience can be improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A device to input a special symbol in an apparatus having a touch screen, comprising:
a touch sensor to detect a user touch at a first position;
a text input controller to switch from a general character input mode to a special symbol input mode if the user touch is maintained for at least a predetermined time; and
a special symbol display unit to display a special symbol at the first position if the text input controller is switched to the special symbol input mode.

2. The device of claim 1, wherein the special symbol display unit sequentially displays a series of special symbols if the user touch is maintained while the text input controller is in the special symbol input mode.

3. The device of claim 1, wherein the special symbol is mapped to a character.

4. The device of claim 3, wherein the special symbol is mapped to the character in a one-to-one basis.

5. The device of claim 3, wherein the special symbol and the character are mapped to each other in a one-to-many basis.

6. The device of claim 3, further comprising:
a mapping setter to map the special symbol to the character.

7. The device of claim 1, wherein if the touch sensor detects a touch at a second position while the text input controller is in the special symbol input mode, the special symbol display unit finishes inputting the special symbol.

8. The device of claim 7, wherein the special symbol display unit finishes inputting the special symbol by inputting the special symbol at the first position, and the text input controller switches back to the general character input mode.

9. The device of claim 1, wherein if the user touch is maintained for less than the predetermined time, the text input controller moves a cursor to the first position and remains in the general character input mode.

10. A method for inputting a special symbol in an apparatus having a touch screen, comprising:
a touch detecting step of detecting a user touch at a first position;
a special symbol input switching step of switching from a general character input mode to a special symbol input mode if the user touch is maintained for at least a predetermined time; and
a special symbol display step of displaying a special symbol at the first position in the special symbol input mode.

11. The method of claim 10, wherein the special symbol display step comprises sequentially displaying a series of special symbols if the user touch is maintained in the special symbol input mode.

12. The method of claim 10, wherein the special symbol is mapped to a character.

13. The method of claim 12, wherein the special symbol is mapped to the character in a one-to-one basis.

14. The method of claim 12, wherein the special symbol and the character are mapped to each other in a one-to-many basis.

15. The method of claim 10, further comprising:
detecting a touch at a second position while in the special symbol input mode;
inputting the special symbol at the first position; and
switching back to the general character input mode.
